(19) United States
(12) Patent Application Publication
(10) Pub. No.: US 2024/0327676 A1
(43) Pub. Date: Oct. 3, 2024

(54) POLISHING COMPOSITION, METHOD FOR PRODUCING SAME, AND POLISHING METHOD

(71) Applicant: FUJIMI INCORPORATED, Kiyosu-shi (JP)

(72) Inventors: Kyosuke Tenko, Kiyosu-shi (JP); Hideharu Hase, Kiyosu-shi (JP); Sae Ohara, Kiyosu-shi (JP)

(73) Assignee: FUJIMI INCORPORATED, Kiyosu-shi (JP)

(21) Appl. No.: 18/618,047

(22) Filed: Mar. 27, 2024

(30) Foreign Application Priority Data
Mar. 30, 2023 (JP) 2023-56494

(51) Int. Cl. C09G 1/02

(52) U.S. Cl. CPC C09G 1/02

(57) ABSTRACT

There are provided a polishing composition less likely to leave cloudiness on the surface of an object to be polished even when there is a time interval before wiping-off, a method for producing the same, and a polishing method.

A polishing composition contains abrasives, a hydrophobic dispersion medium, water, and a surfactant. The surfactant contains polyoxyethylene alkyl ether represented by Formula (i) RO—(C₂H₄O)ₙ—H. In Formula (i), R is a branched-chain alkyl group having a number of carbon atoms of 12 or more and 20 or less, and n represents the average number of added moles of oxyethylene and is 3 or more and 50 or less.

### TECHNICAL FIELD

The present invention relates to a polishing composition, a method for producing the same, and a polishing method.

### BACKGROUND ART

Buffing processing is known as a processing method for smoothing and glossing the surface of a resin coating film applied to surfaces of vehicle bodies of automobiles and the like. The buffing processing is a processing method including pressing a rotating buff against an object to be polished (e.g., resin coating film) to polish the surface while a polishing composition is placed between a cloth buff, for example, and the object to be polished.

The polishing composition used for the buffing processing contains abrasives (polishing materials) and a surfactant. As the abrasives, aluminum oxide (alumina) particles are used, for example, (see PTLS 1 to 3, for example).

### CITATION LIST

### Patent Literatures

PTL 1: JP 2008-255232 A
PTL 2: JP 2008-127456 A
PTL 3: JP 2007-277379 A

### SUMMARY OF INVENTION

### Technical Problem

After the completion of the buffing processing, the surface of the resin coating film needs to be cleaned to wipe off the polishing composition. The buffing processing using a conventional polishing composition has tended to leave white cloudiness on the finished surface after cleaning when there is a time interval before the wiping-off. The white cloudiness is difficult to remove even after cleaning is repeated, and therefore rework, such as re-performing the buffing processing, is required.

The present invention has been made in view of the above-described circumstances. It is an object of the present invention to provide a polishing composition less likely to leave cloudiness on the surface of an object to be polished even when there is a time interval before wiping-off, a method for producing the same, and a polishing method.

### Solution to Problem

To solve the above-described problem, a polishing composition according to one aspect of the present invention contains abrasives, a hydrophobic dispersion medium, water, and a surfactant. The surfactant contains polyoxyethylene alkyl ether represented by Formula (i) RO—(C₂H₄O)ₙ—H. In Formula (i) above, R is a branched-chain alkyl group having a number of carbon atoms of 12 or more and 20 or less, and n represents the average number of added moles in oxyethylene and is 3 or more and 50 or less.

### Advantageous Effects of Invention

One aspect of the present invention can provide a polishing composition less likely to leave cloudiness on the surface of an object to be polished even when there is a time interval before wiping-off, a method for producing the same, and a polishing method.

### BRIEF DESCRIPTION OF DRAWINGS

FIG. 1 is a view illustrating one example of a polishing device used in an embodiment of the present invention.

### DESCRIPTION OF EMBODIMENTS

An embodiment of the present invention will now be described in detail. The embodiment described below illustrates one example of the present invention, and the present invention is not limited to the embodiment. The embodiment described below can be variously altered or improved, and such altered or improved aspects may also be included in the present invention.

### <Polishing Composition>

A polishing composition according to the embodiment of the present invention (hereinafter referred to as this embodiment) contains abrasives, a hydrophobic dispersion medium (organic solvent), water, and a surfactant. The surfactant contains polyoxyethylene alkyl ether represented by Formula (i) RO—(C₂H₄O)ₙ—H. In Formula (i), R is a branched-chain alkyl group having a number of carbon atoms of 12 or more and 20 or less, and n represents the average number of added moles of oxyethylene (C₂H₄O) and is 3 or more and 50 or less.

The polishing composition having such a configuration can suppress the components of the polishing composition from sticking to the surface of the polishing composition even when there is a time interval before wiping-off, and is less likely to leave cloudiness on the surface of an object to be polished. The polishing composition can suppress the sticking components causing cloudiness from remaining on the polished surface of the object to be polished. The polishing composition can suppress the sticking components from reducing the ability to achieve sufficient gloss on the polished surface.

Hereinafter, each component contained in the polishing composition according to this embodiment is described giving examples.

### (1) (Abrasives)

The polishing composition according to this embodiment contains abrasives. The abrasives have an action of mechanically polishing the object to be polished. Specific examples of the abrasives used in this embodiment include metal oxides, such as aluminum oxide (alumina), silicon oxide (silica), cerium oxide (ceria), zirconium oxide, titanium oxide (titania), tin oxide, and manganese oxide, metal carbides, such as silicon carbide and titanium carbide, metal nitrides, such as silicon nitride and titanium nitride, metal borides, such as titanium boride and tungsten boride, silicate compounds, such as zircon (ZrSiO₄), diamond, and the like, for example. The abrasives may be used alone or two or more kinds thereof may be mixed for use. As the abrasives, commercially available products may be used or synthetic products may be used.

Among these abrasives, at least one selected from the group consisting of metal oxides and metal carbides is preferable, silicon carbide, silicon dioxide, or metal oxides are more preferable, at least one of aluminum oxide (alumina), cerium oxide, and zirconium oxide is still more preferable, and aluminum oxide is particularly preferable, from the viewpoint that those having various particle diameters are readily available and excellent polishing rates can be obtained. Further, a mixture of alumina and zircon, for example, can also be preferably used. In this specification, the “polishing rate” may also be referred to as a polishing removal rate.

Among aluminum oxides, those containing an α-phase or those containing crystal phases in a transition state in a process of becoming an α-phase, such as a θ-phase, a δ-phase, and γ-phase, as crystal structures preferable as polishing abrasives are suitable. Those containing an α-phase or a θ-phase are preferable, and those containing an α-phase are more preferable. The α-phase is considered to have an optimal range depending on the degree of the α-phase transformation.

In general, the crystal structure of the α-phase is the hardest, but it is estimated that, when the abrasives are sufficiently sintered at a high temperature to achieve the α-phase transformation, the particle shape is changed to a round shape, so that the polishing performance deteriorates. As a value indicating the degree of the α-phase contained in aluminum oxide, the α-transformation rate is useful as a reference. A preferable lower limit of the α-transformation rate is 50% or more. The lower limit of the α-transformation rate is more preferably 60% or more, still more preferably 70% or more, particularly preferably 80% or more, and yet still more preferably 90% or more. A preferable upper limit of the α-transformation rate is 100% or less. The upper limit of the α-transformation rate is more preferably 98% or less. More specifically, the aluminum oxide has the α-transformation rate of preferably 50% or more and 100% or less and more preferably 60% or more and 98% or less.

By setting the α-transformation rate within the preferable ranges above, an improvement of the polishing power, i.e., an increase in a scratch removal rate and an increase in the polishing rate, is expected. The α-transformation rate of aluminum oxide particles can be calculated from the integrated intensity ratio of the (113) plane diffraction line by X-ray diffraction measurement using an X-ray diffraction device (Ultima-IV, manufactured by Rigaku Co., Ltd.).

The lower limit of the volume average particle diameter (average secondary particle diameter) of the abrasives is preferably 0.05 μm or more, more preferably 0.1 μm or more, and still more preferably 0.2 μm or more. Due to the fact that the volume average particle diameter (average secondary particle diameter) of the abrasives is 0.05 μm or more, processing power can be improved, and thus the object to be polished can be satisfactorily polished in both rough polishing and final polishing.

The upper limit of the volume average particle diameter (average secondary particle diameter) of the abrasives is preferably 15 μm or less, more preferably 10 μm or less, still more preferably 5 μm or less, particularly preferably 4 μm or less, and most preferably 3 μm or less. With a decrease in the volume average particle diameter (average secondary particle diameter) of the abrasives, it becomes easier to obtain a surface with fewer defects and low roughness.

Therefore, due to the fact that the volume average particle diameter (average secondary particle diameter) of the abrasives is 0.05 μm or more and 15 μm or less, a surface with fewer defects and low roughness can be obtained while the processing power is improved.

Abrasives may be used which contain polishing particles having a large particle diameter before polishing but decreasing in size at the interface between the buff and the object to be polished during polishing (abrasives in which secondary particles are broken to be primary particles during polishing). From the above, the volume average particle diameter (average secondary particle diameter) of the abrasives is preferably 0.05 μm or more and 15 μm or less, more preferably 0.1 μm or more and 10 μm or less, still more preferably 0.2 μm or more and 5 μm or less, particularly preferably 0.2 μm or more and 4 μm or less, and most preferably 0.2 μm or more and 3 μm or less. In one embodiment, the volume average particle diameter (average secondary particle diameter) of the abrasives is 0.05 μm or more and 10 μm or less, 0.2 μm or more and 4 μm or less, and 0.2 μm or more and 3 μm or less.

In this specification, the volume average particle diameter of the abrasives is defined as the cumulative 50% particle diameter (D50) based on the volume-based grain size distribution. More specifically, the D50 is a particle diameter at which the cumulative volume from the large particle diameter side (or small particle diameter side) in a volume-based cumulative particle diameter distribution reaches 50%. The D50 of the abrasives can be measured utilizing a commercially available grain size measuring device. Such a grain size measuring device may be based on any technique, such as dynamic light scattering, laser diffraction, laser scattering, or resistive pulse sensing. Examples of a D50 measuring method and a D50 measuring device include a measuring method and a measuring device, respectively, described in Examples.

The lower limit of the content of the abrasives in the polishing composition is preferably 0.1 mass % or more, more preferably 1 mass % or more, still more preferably 5 mass % or more, particularly preferably 7 mass % or more, and most preferably 10 mass % or more based on the total mass of the polishing composition. Due to the fact that the content of the abrasives is 0.1 mass % or more, the processing power is appropriately controlled, and the object to be polished can be satisfactorily polished in both rough polishing and final polishing.

The upper limit of the content of the abrasives in the polishing composition is preferably 50 mass % or less, more preferably 35 mass % or less, still more preferably 30 mass % or less, particularly preferably 20 mass % or less, and most preferably 15 mass % or less based on the total mass of the polishing composition. Due to the fact that the content of the abrasives is 50 mass % or less, the production cost of the polishing composition can be reduced and a surface with fewer defects and low roughness can be obtained.

In one preferable embodiment, the abrasives are contained in a proportion of 5 mass % or more and 30 mass % or less based on the total mass of the polishing composition.

### (2) Other Examples of Abrasives

In the polishing composition according to this embodiment, the abrasives are not limited to the examples described in (1) above. In the polishing composition according to this embodiment, the abrasives may be abrasives of another example 1 or 2 described below.

### (2.1) Another Example 1

As the abrasives of this embodiment, abrasive may be used which have a value of the shape parameter of 0.6 or more and 60 or less, preferably 0.8 or more and 50 or less, and more preferably 1.0 or more and 40 or less, the value of the shape parameter being obtained by dividing the specific surface area (m²/g) of the abrasives by the square of the particle diameter D50 (μm).

In the abrasives having the above-described shape parameters, abrasives may be used which have the average secondary particle diameter of 0.05 μm or more and 10 μm or less. This can provide a surface with few defects and low roughness while improving the processing power. In the abrasives having the shape parameters above, the specific surface area (m²/g) of the abrasives is preferably 2.1 or more and 21 or less, more preferably 8 or more and 20 or less, and still more preferably 12 or more and 15 or less. This can improve the finished surface of the object to be polished after polishing.

Also in this example, the abrasives may contain aluminum oxide, for example, and preferably contain sintered alumina having a larger number of irregularities on the surface than that of melted alumina.

By polishing the surface of the object to be polished using the polishing composition containing such abrasives, the polishing rate (μm/min) in the object to be polished and the scratch removal performance to the object to be polished (e.g., performance of reducing the number of scratches and performance of reducing the depth of scratches) can be individually improved.

### (2.2) Another Example 2

As the abrasives of this embodiment, abrasives may be used which have a grain size distribution width (D10-D90)/D50 of the abrasives of 0.4 or more and 2.0 or less and a specific surface area (m²/g) of 12 or more and 20 or less.

Herein, D10, D50, D90 are particle diameters at which the cumulative volume from the large particle diameter side in the volume-based cumulative particle diameter distribution reaches 10%, 50%, 90%, respectively. The D10, D50, D90 can be measured utilizing a commercially available grain size measuring device.

In this example, the grain size distribution width (D10-D90)/D50 of the abrasives is preferably 0.4 or more and 1.8 or less and more preferably 0.4 or more and 1.6 or less. The specific surface area (m²/g) of the abrasives is preferably 12 or more and 18 or less and more preferably 12 or more and 15 or less. When the grain size distribution width of the abrasives is smaller than the lower limit of the grain size distribution width above, the polishing rate hardly rises. When the grain size distribution width of the abrasives is larger than the upper limit of the grain size distribution width above, scratches are likely to be generated in the object to be polished after polishing. When the specific surface area (m²/g) of the abrasives is smaller than the lower limit of the specific surface area above, scratches are likely to be generated in the object to be polished after polishing. When the specific surface area (m²/g) of the abrasives is larger than the upper limit of the specific surface area above, the polishing rate hardly increases. By setting both the grain size distribution width and the specific surface area within the ranges above, the object to be polished can be polished at a high polishing rate, and the finished surface after polishing can be improved. More specifically, the performance of the polishing composition can be enhanced.

Abrasives may be used which have an average secondary particle diameter of 0.05 μm or more and 10 μm or less in addition to the above-described configuration.

Abrasives may be used which have a value of the shape parameter of 0.6 or more and 60 or less in addition to the above-described configuration, the value of the shape parameter being obtained by dividing the specific surface area (m²/g) of the abrasives by the square of the particle diameter D50 (μm).

Also in this example, the abrasives may contain aluminum oxide, for example, and preferably contain sintered alumina having a larger number of irregularities on the surface than that of melted alumina.

By polishing the surface of the object to be polished using the polishing composition containing such abrasives, the polishing rate (μm/min) in the object to be polished and the scratch removal performance to the object to be polished (e.g., performance of reducing the number of scratches and performance of reducing the depth of scratches) can be individually improved.

### (3) Hydrophobic Dispersion Medium

The polishing composition according to this embodiment contains the hydrophobic dispersion medium. The hydrophobic dispersion medium contains at least one selected from the group consisting of normal paraffinic hydrocarbons, isoparaffinic hydrocarbons, naphthenic hydrocarbons, and terpene hydrocarbons, for example. The hydrophobic dispersion medium preferably has a vapor pressure at 20° C. of 0.004 kPa or more and 2 kPa or less. The hydrophobic dispersion medium preferably has a flash point of 30° C. or more and 100° C. or less. By using such a hydrophobic dispersion medium, the processing efficiency (polishing removal rate) when a resin coating film is subjected to the buffing processing is improved. In the following description, the normal paraffinic hydrocarbons, the isoparaffinic hydrocarbons, the naphthenic hydrocarbons, and the terpene hydrocarbons, which may be contained in the hydrophobic dispersion medium, are sometimes referred to as an “organic solvent”.

The hydrophobic dispersion medium and the organic solvent in this embodiment are preferably those hardly soluble in water. As the hydrophobic dispersion medium and the organic solvent, commercially available products may be used or synthetic products may be used.

The normal paraffinic hydrocarbons, the isoparaffinic hydrocarbons, the naphthenic hydrocarbons, and the terpene hydrocarbons are preferably derived from mineral oil or may be extracted and refined from mineral oil-derived components or may be synthesized from mineral oil-derived components as raw materials (mineral oil-derived synthetic hydrocarbons). The normal paraffinic hydrocarbons, the isoparaffinic hydrocarbons, the naphthenic hydrocarbons, and the terpene hydrocarbons are more preferably mineral oil-derived synthetic hydrocarbons. These hydrophobic organic solvents are generally known to have lower toxicity than that of other halogen-based or benzene-based organic solvents and have higher volatility than that of other polyethylene glycols and the like.

The normal paraffinic hydrocarbons include straight-chain hydrocarbons, liquid paraffin, kerosene, light oil, and the like having a number of carbon atoms of about 5 or more and 30 or less, for example.

The isoparaffinic hydrocarbons include branched hydrocarbons, liquid isoparaffin, and the like having a number of carbon atoms of about 5 or more and 40 or less, for example.

The naphthenic hydrocarbons include cyclic hydrocarbons having a number of carbon atoms of about 5 or more and 40 or less, e.g., monocyclic cycloparaffins, such as cyclohexane, cyclopentane, and cyclononane; polycyclic cycloparaffins, such as decalin; alkylcycloparaffins, such as methyl cyclopentane, methyl cyclohexane, 1-methyl-4-isopropylcyclohexane, butylcyclohexane, and methyl decalin; and the like, for example.

The terpene hydrocarbons include, for example, chain terpene hydrocarbons, such as myrcene, farnesene, and citral; and cyclic terpene hydrocarbons, such as menthol, cineole, pinene, limonene, α-terpinene, γ-terpinene, camphene, phellandrene, terpinene, terpinolene, p-cymene, and cedrene, for example.

The hydrophobic dispersion medium may further contain organic solvents other than the above-described hydrocarbons.

In the following description, organic solvents other than the normal paraffinic hydrocarbons, the isoparaffinic hydrocarbons, the naphthenic hydrocarbons, and the terpene hydrocarbons are referred to as “other organic solvents”. Examples of such other organic solvents include methyl alcohol, ethyl alcohol, isopropyl alcohol, acetone, diethyl ether, ethyl acetate, butyl acetate, triethyl citrate, acetyl tributyl citrate, acetyl triethyl citrate, and the like, for example.

The hydrophobic dispersion medium (organic solvent) generally has a flash point. The flash point is the lowest temperature at which, when a liquid is heated at a constant temperature and a flame is brought close to the heated liquid, vapor having a concentration required for instantaneous ignition is generated. The flash point can also be said to be the lowest temperature at which the hydrophobic dispersion medium can be volatilized to form a flammable mixture with air. Methods for measuring the flash point are different depending on the purpose of the measurement or the properties of samples. Methods for measuring the flash point include a closed cup method and an open cup method. As the closed method, a tag closed cup method (JIS K 2265-1:2007), a seta closed cup method (JIS K 2265-2:2007), Pensky-Martens closed cup method (JIS K 2265-3:2007), and the like are used, for example. As the open cup method, a Cleveland open cup method (JIS K 2265-4:2007) and the like are used.

### (4) Water

The polishing composition according to this embodiment contains water. From the viewpoint of suppressing the inhibition of the action of other components, water is preferably water containing as little impurities as possible, and specifically, pure water or ultrapure water obtained by removing impurity ions with an ion exchange resin, and then removing contaminants through a filter or distilled water.

The lower limit of the content of water in the polishing composition is preferably 1 mass % or more, more preferably 5 mass % or more, still more preferably 10 mass % or more, particularly preferably 15 mass % or more, and most preferably 20 mass % or more based on the total mass of the polishing composition. The upper limit of the content of water in the polishing composition is preferably 90 mass % or less, more preferably 85 mass % or less, still more preferably 80 mass % or less, particularly preferably 75 mass % or less, and most preferably 70 mass % or less based on the total mass of the polishing composition.

More specifically, the content of water in the polishing composition is preferably 1 mass % or more and 90 mass % or less, more preferably 5 mass % or more and 85 mass % or less, still more preferably 10 mass % or more and 80 mass % or less, particularly preferably 15 mass % or more and 75 mass % or less, and most preferably 20 mass % or more and 70 mass % or less. Due to the fact that the content of water falls within the ranges above, the processing power can be improved and the object to be polished can be satisfactorily polished in both rough polishing and final polishing.

### (5) Surfactant

The polishing composition according to this embodiment contains a surfactant. The surfactant disperses or emulsifies the hydrophobic dispersion medium or water. The surfactant imparts hydrophilicity to the surface to be polished after polishing to thereby improve the cleaning efficiency of the surface to be polished after polishing, and therefore can prevent the adhesion of dirt to the surface to be polished, for example. Further, the surfactant according to this embodiment contributes to the stability after emulsification.

As described above, the surfactant of this embodiment contains the polyoxyethylene alkyl ether represented by Formula (i) RO—(C₂H₄O)ₙ—H. In Formula (i), R is a branched-chain alkyl group having a number of carbon atoms of 12 or more and 20 or less, and n represents the average number of added moles of oxyethylene and is 3 or more and 50 or less. The average number of added moles n is preferably 5 or more and 20 or less and more preferably 5 or more and 15 or less.

The surfactant of this embodiment contains, as the polyoxyethylene alkyl ether represented by Formula (i), at least one selected from the group consisting of polyoxyethylene alkyl ether (C12-14 secondary alcohol), polyoxyethylene octyl dodecyl ether, and polyoxyethylene 2-hexyl decyl ether, for example. The C12-14 secondary alcohol indicates those having a number of carbon atoms of R of 12, 13, 14 or a mixture of two or more types thereof in the polyoxyethylene alkyl ether represented by Formula (i) (The same applies hereinafter.).

The polyoxyethylene alkyl ether represented by Formula (i) may be referred to as polyoxyethylene secondary alcohol ether, secondary alcohol ethoxylate, polyoxyethylene alkyl ether (secondary alcohol), or polyoxyethylene secondary alkyl ether. In any name, the structure is the same as that of the polyoxyethylene alkyl ether represented by Formula (i).

The content of the surfactant in the polishing composition is preferably 0.01 mass % or more and more preferably 0.1 mass % or more based on the total mass of the polishing composition. The content of the surfactant in the polishing composition is preferably 3.0 mass % or less and more preferably 2.0 mass % or less based on the total mass of the polishing composition. When the content of the surfactant falls within the ranges above, the stability of an emulsion in the polishing composition increases.

For example, the HLB value indicating the affinity with water and oil of the surfactant is 10 or more and 16 or less and preferably 10 or more and 14 or less.

### (6) Various Additives

The polishing composition according to this embodiment may contain various additives, such as a pH adjuster, a polishing removal accelerator, an oxidant, a dispersant, a viscosity modifier, a complexing agent, an anticorrosion agent, an antifungal agent, and the like to improve the performance of the polishing composition. Examples of the additives that can be compounded in the polishing composition of this embodiment are described below.

### (6.1) pH Adjuster

The polishing composition according to this embodiment may contain a pH adjuster. The pH value of the polishing composition can be adjusted by adding the pH adjuster. The PH adjuster used as required to adjust the pH value of the polishing composition to a desired value may be either acids or alkalis or may be either inorganic compounds or organic compounds.

Specific examples of the acids as the pH adjuster include inorganic acids, carboxylic acids and organic acids, such as organic sulfuric acids. Specific examples of the inorganic acids include sulfuric acid, nitric acid, boric acid, carbonic acid, hypophosphorous acid, phosphorous acid, phosphoric acid, and the like. Specific examples of the carboxylic acids include formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, and the like. Specific examples of the organic sulfuric acids include methanesulfonic acid, ethanesulfonic acid, isethionic acid, and the like. One kind of the acids may be used alone or two or more kinds thereof may be used in combination.

Specific examples of bases as the pH adjuster include alkali metal hydroxides or salts thereof, alkaline earth metal hydroxides or salts thereof, quaternary ammonium hydroxides or salts thereof, ammonia, amines, and the like.

Specific examples of the alkali metals include potassium, sodium, and the like. Specific examples of the alkaline earth metals include calcium, strontium, and the like. Specific examples of the salts include carbonates, hydrogen carbonates, sulfates, acetates, and the like. Specific examples of the quaternary ammonium include tetramethylammonium, tetraethylammonium, tetrabutylammonium, and the like.

Quaternary ammonium hydroxide compounds include quaternary ammonium hydroxides or salts thereof. Specific examples include tetramethylammonium hydroxide, tetraethylammonium hydroxide, tetrabutylammonium hydroxide, and the like.

Specific examples of the amines include methylamine, dimethylamine, trimethylamine, ethylamine, diethylamine, triethylamine, ethylenediamine, monoethanolamine, N-(β-aminoethyl) ethanolamine, hexamethylenediamine, diethylenetriamine, triethylenetetramine, anhydrous piperazine, piperazine hexahydrate, 1-(2-aminoethyl) piperazine, N-methylpiperazine, guanidine, and the like.

One kind of the bases may be used alone or two or more kinds thereof may be used in combination.

Among the bases, ammonia, ammonium salts, alkali metal hydroxides, alkali metal salts, quaternary ammonium hydroxide compounds, and amines are preferable, and ammonia, potassium compounds, sodium hydroxides, quaternary ammonium hydroxide compounds, ammonium hydrogen carbonates, ammonium carbonates, sodium hydrogen carbonates, and sodium carbonates are more preferable.

The polishing composition more preferably contains potassium compounds as the base from the viewpoint of preventing metal contamination. The potassium compounds include potassium hydroxides or potassium salts. Specific examples include potassium hydroxide, potassium carbonate, potassium hydrogen carbonate, potassium sulfate, potassium acetate, potassium chloride, and the like.

In place of the acids above or in combination with the acids above, salts, such as ammonium salts or alkali metal salts of the acids above, may be used as the pH adjuster serving as a buffer. In particular, when the combination of the acid and the buffer is set as a combination of a weak acid and a strong base, a strong acid and a weak base, or a weak acid and a weak base, a pH buffering effect can be expected.

### (6.2) Polishing Removal Accelerator (Oxidant)

The polishing composition according to this embodiment may contain a polishing removal accelerator. The polishing removal accelerator plays the role of chemically polishing the object to be polished, and can significantly increase the processing efficiency by acting on the outer surface of the resin coating film.

Specific examples of the polishing removal accelerator include those containing at least one of salt selected from the group consisting of metal salts of inorganic acids, metal salts of organic acids, ammonium salts of inorganic acids, and ammonium salts of organic acids.

The inorganic acids may be any of nitric acid, sulfuric acid, and hydrochloric acid. The organic acids may be any of oxalic acid, lactic acid, acetic acid, formic acid, citric acid, tartaric acid, malic acid, gluconic acid, glycolic acid, and malonic acid. The metal salts may be any of aluminum salt, nickel salt, lithium salt, magnesium salt, sodium salt, and potassium salt.

One kind of the polishing removal accelerators may be used alone or two or more kinds thereof may be used in combination.

Further, oxidants may be added as the polishing removal accelerator. Specific examples of the oxidants include hydrogen peroxide, peroxide, nitrate, iodate, periodate, hypochlorite, chlorite, chlorate, perchlorate, persulfate, dichromate, permanganate, ozone water, silver (II) salt, iron (III) salt, and the like.

### (6.3) Dispersant/Viscosity Modifier (Thickener)

The polishing composition according to this embodiment may contain a dispersant or a thickener. The dispersant or the thickener enables the abrasives to efficiently act on the object to be polished by uniformly dispersing the abrasives (abrasive materials) in a liquid. Due to the presence of the dispersant or the thickener between the abrasives, the action of suppressing the caking of the abrasives can also be expected. This can suppress the generation of scratches caused by the aggregated abrasives.

Specific examples of the dispersant include, as colloidal substances as substances containing fine particles, colloidal alumina, colloidal silica, colloidal zirconia, colloidal titania, alumina sol, silica sol, zirconia sol, titania sol, fumed alumina, fumed silica, fumed zirconia, fumed titania, and the like, for example. Sodium phosphate, sodium hexametaphosphate, sodium pyrophosphate, and the like, which are generally used as the dispersant, may be used.

Specific examples of the thickener include glycols, such as propylene glycol polymers and ethylene glycol polymers, and polymer compounds. More specifically, glycols include propylene glycol, ethylene glycol, dipropylene glycol, polypropylene glycol, diethylene glycol, polyethylene glycol, and the like. The polymer compounds include sodium polyacrylate, polyvinyl alcohol, hydroxyethyl cellulose, and the like.

### (6.4) Complexing Agent

The polishing composition according to this embodiment may contain an agent having a chelating action (complexing agent). The complexing agent confines metal ions and the like derived from a polishing device, the object to be polished, and the like, and therefore can be expected to suppress metal contamination of the polished surface due to metal ions and provide a good polished surface.

The complexing agent include organic acids, amino acids, nitrile compounds, and chelating agents other than the substances above, for example. Specific examples of the organic acids include oxalic acid, malonic acid, succinic acid, glutaric acid, adipic acid, pimelic acid, maleic acid, phthalic acid, malic acid, tartaric acid, citric acid, and the like. In place of the organic acids or in combination with the organic acids, salts, such as alkali metal salts of the organic acids, may be used.

Specific examples of the amino acids include glycine, α-alanine, β-alanine, N-methyl glycine, N, N-dimethylglycine, 2-aminobutyric acid, norvaline, valine, leucine, norleucine, isoleucine, phenylalanine, proline, sarcosine, ornithine, lysine, taurine, serine, threonine, homoserine, tyrosine, bicine, tricine, 3,5-diiodo-tyrosine, β-(3,4-dihydroxyphenyl)-alanine, thyroxine, 4-hydroxy-proline, cysteine, methionine, ethionine, lanthionine, cystathionine, cystine, cysteic acid, aspartic acid, glutamic acid, S-(carboxymethyl)-cysteine, 4-aminobutyric acid, asparagine, glutamine, azaserine, arginine, canavanine, citrulline, δ-hydroxy-lysine, creatine, histidine, 1-methyl-histidine, 3-methyl-histidine, tryptophan, and the like.

Specific examples of the nitrile compounds include acetonitrile, aminoacetonitrile, propionitrile, butyronitrile, isobutyronitrile, benzonitrile, glutarodinitrile, methoxyacetonitrile, and the like, for example.

Specific examples of the chelating agents other than the substances above include iminodiacetic acid, nitrilotriacetic acid, diethylenetriamine pentaacetic acid, ethylenediaminetetraacetic acid, N,N,N-trimethylene phosphonic acid, ethylenediamine-N,N,N′,N′-tetramethylene sulfonic acid, transcyclohexanediaminetetraacetic acid, 1,2-diaminopropane tetracetic acid, glycol ether diamine tetracetic acid, ethylene diamine orthohydroxy phenylacetic acid, ethylene diaminedisuccinic acid (SS isomer), N-(2-carboxylateethyl)-L-aspartic acid, β-alanine diacetic acid, 2-phosphonobutane-1,2,4-tricarboxylic acid, 1-hydroxyethylidene-1,1-diphosphonic acid, N,N′-bis(2-hydroxybenzyl)ethylene diamine-N,N′-diacetic acid, 1,2-dihydroxy benzene-4,6-disulfonic acid, and the like.

One kind of the complexing agents may be used alone or two or more kinds thereof may be mixed for use.

### (6.5) Anticorrosion Agent

The polishing composition according to this embodiment may contain an anticorrosion agent. The anticorrosion agent forms a protective film on the metal surface, and therefore can be expected to prevent the corrosion of polishing devices, objects to be polished, fixtures, and the like.

Usable anticorrosion agents are not particularly limited and are heterocyclic compounds or surfactants, for example. The number of heterocyclic rings in the heterocyclic compounds is not particularly limited. The heterocyclic compounds may be monocyclic compounds or may be polycyclic compounds having a condensed ring. One kind of the anticorrosion agents may be used alone or two or more kinds thereof may be mixed for use.

Specific examples of the heterocyclic compounds usable as the anticorrosion agent include nitrogen-containing heterocyclic compounds, such as a pyrrole compound, a pyrazole compound, an imidazole compound, a triazole compound, a tetrazole compound, a pyridine compound, a pyrazine compound, a pyridazine compound, a pyridine compound, an indolizine compound, an indole compound, an isoindole compound, an indazole compound, a purine compound, a quinolizine compound, a quinoline compound, an isoquinoline compound, a naphthyridine compound, a phthalazine compound, a quinoxaline compound, a quinazoline compound, a cinnoline compound, a pteridine compound, a thiazole compound, an isothiazole compound, an oxazole compound, an isoxazole compound, and a furazan compound, for example.

### (6.6) Antifungal Agent and Antiseptic

The polishing composition according to this embodiment may contain antifungal agents and antiseptics. Specific examples of the antifungal agents and the antiseptics include isothiazoline antiseptics (e.g., 2-methyl-4-isothiazoline-3-one, 5-chloro-2-methyl-4-isothiazoline-3-one), paraoxybenzoates, and phenoxyethanol. One kind of the antifungal agents and the antiseptics may be used alone or two or more kinds thereof may be used in combination.

### <Method for Producing Polishing Composition>

A method for producing a polishing composition according to this embodiment includes a step of mixing abrasives, a hydrophobic dispersion medium, water, and a surfactant to produce a polishing composition. The surfactant contains the polyoxyethylene alkyl ether represented by Formula (i) RO—(C₂H₄O)ₙ—H. In Formula (i), R is a branched-chain alkyl group having a number of carbon atoms of 12 or more and 20 or less, and n represents the average number of added moles of oxyethylene and is 3 or more and 50 or less.

Such a production method can produce a polishing composition less likely to leave cloudiness on the surface of the object to be polished even when there is a time interval before wiping-off.

In the above-described production method, it is preferable to mix the hydrophobic dispersion medium and the surfactant in advance, and then mix the resultant mixture with water and the abrasives. When the polishing composition of the present invention contains hydrophilic components, such as thickeners and emulsion stabilizers, it is preferable to prepare a hydrophobic mixture by mixing the hydrophobic dispersion medium and the surfactant and prepare a hydrophilic mixture by mixing water and a hydrophilic component in advance, and then mix the hydrophobic mixture, the hydrophilic mixture, and the abrasives.

When the polishing composition of the present invention contains other components, such as pH adjusters, it may be acceptable that the hydrophobic dispersion medium, the surfactant, water, and the abrasives are mixed, and then, as required, other components, such as pH adjusters, are stirred and mixed.

The temperature at which each component is mixed is not particularly restricted, and is preferably 10° C. or more and 40° C. or less, for example. The mixing time is not particularly restricted.

### (Specific Examples of Method for Producing Abrasives)

A method for producing abrasives (secondary particles) is further described giving specific examples. As described above, the abrasives may be aluminum oxide (alumina) in this embodiment. A method for producing alumina is not particularly limited, and includes a method including appropriately grinding and/or classifying powder obtained by firing a starting raw material, such as aluminum oxide precursor powder, as one example.

The shape of the abrasives, including the surface irregularity degree, can be controlled by the type and the firing conditions of the starting raw material of aluminum oxide.

The aluminum oxide precursor powder may be aluminum hydroxide powder or aluminum oxide powder containing a transitional aluminum oxide phase. The aluminum hydroxide powder may be gibbsite, boehmite, pseudoboehmite, diaspore, or any combination thereof. The aluminum oxide precursor powder can contain gamma (γ), eta (η), theta (θ), chi (χ), kappa (κ), and/or delta (δ)-phase aluminum oxide(s).

Aluminum oxide (alumina) can be formed by firing the aluminum oxide precursor powder described above. A firing method is not particularly limited, and a rotary kiln, a tunnel kiln, an electric furnace, a muffle furnace, an elevator kiln, or a pusher kiln is usable as one example. As the firing conditions, the firing temperature can be about 700 to 1600° C. and the firing time can be about 1 to 48 hours. Thus, α-alumina having a suitable α-transformation rate can be obtained. The higher the firing temperature and the longer the firing time, the smaller the surface irregularity degree tends to be, i.e., the smaller the specific surface area tends to be.

By appropriately grinding and classifying the fired alumina powder, alumina having a desired particle diameter distribution can be obtained. The grinding and classification can be performed in a wet or dry process.

As examples of grinding methods, various devices including a roller mill, a jet mill, a high-speed rotary grinder, and a vessel driven mill are usable. In each device, alumina having a desired grain size distribution can be obtained by changing the grinding conditions, such as the grinding time.

As examples of classification methods, various methods including filtering, sieving, pneumatic classification, levigation classification, weight classification, inertial classification, and centrifugal classification are usable. As examples of filtering, various filtration techniques including coarse filtration, microfiltration, ultrafiltration, and reverse osmosis are usable. Filters used for filtering include mesh filters, depth filters, and membrane filters, for example. In filtering, the grain size distribution of the powder can be controlled by the filtration time, the filtration speed, and the filtration accuracy. For example, the filtration accuracy can be 0.1 to 300 μm.

By appropriately selecting and/or combining one or more of the above-described firing methods, grinding methods, and classification/filtering methods and controlling the respective conditions, alumina having a desired grain size distribution and a desired specific surface area can be obtained.

### <Objects to be Polished>

The objects to be polished according to this embodiment are not particularly restricted and preferably contain at least one selected from the group consisting of alloy materials, resin materials, metals, metalloids, metal oxides, metal carbides, metal nitrides, metalloid oxides, metalloid carbides, metalloid nitrides, and glass materials, and may also be composite materials of these materials. Particularly, resin materials (resin coating films) used for coated surfaces of automobile bodies and the like are preferable.

The type of the resin coating film is not particularly limited. A resin constituting the resin coating film is preferably a urethane resin and an acrylic resin. The type of the resin may be a urethane resin and an acrylic resin alone and a mixture thereof. Further, the resin coating film may also be a transparent clear coating film. The thickness of the resin coating film is not particularly limited, and may be set to 100 μm or less and may be set to 10 μm or more and 40 μm or less. The hardness of the resin can be adjusted by the drying temperature. In general, the resin is soft when the drying temperature is around 60° C. and the resin is hard when the drying temperature is around 140° C. When the polishing composition according to this embodiment is applied to the buffing processing of such a resin coating film, an improvement of the wiping property after polishing can be realized while the processing efficiency is improved.

The polishing composition of this embodiment is usable for producing a coated part obtained by covering the surface of a base material with a resin coating film. When the outer surface of the resin coating film of the coated part is polished using the polishing composition of this embodiment, the coated part including the resin coating film can be produced which is less likely to leave cloudiness on the surface of the object to be polished and has a beautiful gloss even when there is a time interval before wiping-off.

The type of the coated part (i.e., application of the resin coating film) is not limited to the automobile bodies. The type of the coated part includes, but is not particularly limited to, railway vehicles, aircrafts, resin parts, and the like, for example.

### <Polishing Method>

A polishing method according to this embodiment includes a step of polishing the object to be polished using the above-described polishing composition or a polishing composition obtained by the above-described production method.

In the step of polishing the object to be polished, the polishing composition is supplied to the surface of the resin coating film as the object to be polished, and the polishing buff is brought into contact with the surface to which the polishing composition has been supplied for polishing, for example. As the polishing buff, a wool buff or a sponge buff or both are used, for example.

The configuration of the polishing device is not particularly limited, and may be a polisher that a worker can hold in his or her hand (hereinafter also referred to as a hand polisher), a general polishing device, such as a single-sided polishing machine, a double-sided polishing machine, a lens polishing machine, a vertical electric polishing machine, or a grinder, or an automatic polishing device.

When the hand polisher is used, a worker manually moves the hand polisher to polish the surface of the object to be polished (e.g., resin coating film). A driving means of the hand polisher is not particularly limited, and a single action, a double action, a gear action, and the like are generally used, and the double action is preferred for polishing the resin coating film.

When the automatic polishing device is used, the automatic polishing device operates a robot arm under the control of a controller to polish the surface of the object to be polished (e.g., resin coating film).

### <Polishing Device>

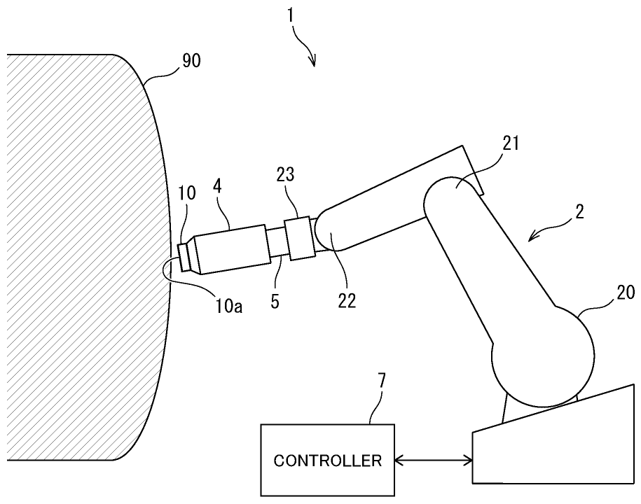

FIG. 1 is a view illustrating one example of a polishing device used in the embodiment of the present invention. An automatic polishing device 1 in FIG. 1 includes a robot arm 2, a polishing buff 10, a polishing tool 4, a pressing force detector 5, and a controller 7. The robot arm 2 has a plurality of joints 20, 21, 22, and therefore can move a tip portion 23 to which the polishing buff 10, the polishing tool 4, and the pressing force detector 5 are attached in a plurality of directions. An object to be polished 90 is a vehicle body of an automobile or the like having a surface coated with a resin coating film, for example.

The polishing tool 4 is attached to the tip portion 23 via the pressing force detector 5, and rotates the polishing buff 10 with a direction perpendicular to a polishing surface 10a of the polishing buff 10 as the rotation axis by a built-in driving means. The controller 7 controls the behavior of the robot arm 2 and the rotation of the polishing buff 10 by the polishing tool 4. From a polishing composition supply mechanism (not illustrated), the polishing composition is supplied between the polishing surface 10a of the polishing buff 10 and a resin coated surface of the object to be polished 90.

The controller 7 polishes the resin coated surface by pressing the polishing surface 10a of the polishing buff 10 against the resin coated surface of the object to be polished 90 by the robot arm 2 and rotating polishing buff 10. The pressing force detector 5 detects the pressing force of the polishing surface 10a of the polishing buff 10 against the resin coated surface. The controller 7 may adjust the force with which the polishing surface 10a is pressed against the resin coated surface based on the detection result of the pressing force by the pressing force detector 5. The controller 7 may control the robot arm 2 such that the polishing buff 10 moves on the resin coated surface resin while the pressing force of the polishing surface 10a against the resin coated surface is kept constant based on the detection result of the pressing force by the pressing force detector 5.

A material of the polishing buff 10 is not particularly limited, and general nonwoven fabrics, suede, wool buffs, woven fabrics, polyurethane foams, polyethylene foams, porous fluororesin, and the like are usable without being particularly restricted. As the polishing buff 10, those provided with a groove in which a liquid polishing composition stays in the polishing surface 10a are usable.

### Examples

Hereinafter, the present invention is more specifically described with reference to Examples and Comparative Examples. However, the technical scope of the present invention is not limited to only Examples described below. Examples and Comparative Examples described below were performed under the conditions of Room temperature (20° C. or more and 25° C. or less)/Relative humidity of 30% RH or more and 50% RH or less.

Table 1 shows the configurations of polishing compositions according to Examples and Comparative Examples of the present invention and the presence or absence of the sticking components to a resin coating film after polishing.

### Preparation of polishing compositions of Examples 1 to 5 and Comparative Examples 1 to 6

To 16 mass % (hereinafter indicated as wt %) of a hydrophobic dispersion medium, 0.8 wt % of a surfactant was added to prepare a solution of the hydrophobic dispersion medium. Subsequently, 1.0 wt % of a polyacrylic acid polymer (thickener) and 2.0 wt % of glycerin (emulsion stabilizer) were mixed with water, the solution was added to the solution of the hydrophobic dispersion medium, followed by stirring at room temperature (25° C.), and then 12 wt % of abrasives shown in Table 1 were added. An antiseptic was added to the obtained dispersion liquid, and sodium hydroxide was added as alkali to adjust the pH to 9.0, thereby producing polishing compositions of Examples 1 to 5 and Comparative Examples 1 to 6 in the form of O/W emulsions. In Table 1, columns marked with - mean no data.

In Table 1, the structure of the R moiety indicates the structure of the alkyl ether moiety in polyoxyethylene alkyl ether, and corresponds to R in Formula (i). In Table 1, the average number of added moles indicates the average number of added moles of oxyethylene (C₂H₄O) or oxyalkylene, and corresponds to n in Formula (i).

TABLE 1

| | | | Average number of | | Wiping | |
|---|---|---|---|---|---|---|
| | Main component of surfactant | Structure of R moiety | added moles | HLB | property | Stability |
| Ex. 1 | Polyoxyethylene alkyl ether | C12-14, Branched-chain | 5 | 10.5 | ∘ | ∘ |
| | (C12-14 secondary ether) | | | | | |
| Ex. 2 | Polyoxyethylene alkyl ether | C12-14, Branched-chain | 7 | 12.1 | ∘ | ∘ |
| | (C12-14 secondary ether) | | | | | |
| Ex. 3 | Polyoxyethylene alkyl ether | C12-14, Branched-chain | 9 | 13.3 | ∘ | ∘ |
| | (C12-14 secondary ether) | | | | | |
| Ex. 4 | Polyoxyethylene alkyl ether | C12-14, Branched-chain | 12 | 14.5 | ∘ | ∘ |
| | (C12-14 secondary ether) | | | | | |
| Ex. 5 | Polyoxyethylene alkyl ether | C12-14, Branched-chain | 15 | 15.3 | ∘ | ∘ |
| | (C12-14 secondary ether) | | | | | |
| Comp. Ex. 1 | Polyoxyalkylene alkyl ether | Straight-chain | — | 13.3 | x | — |
| Comp. Ex. 2 | Polyoxyalkylene alkyl ether | Straight-chain | — | 14.7 | x | — |
| Comp. Ex. 3 | Polyoxyalkylene alkyl ether | Straight-chain | — | 15.2 | x | — |
| Comp. Ex. 4 | Polyoxyethylene decyl ether | C10, Straight-chain | 7 | 13.2 | x | — |
| Comp. Ex. 5 | Polyoxyethylene isodecyl ether | C10, Branched-chain | 6.5 | 12.8 | x | — |
| Comp. Ex. 6 | Polyoxyethylene tridecyl ether | C13, Straight-chain | 8.5 | 13.4 | x | — |

In Examples 1 to 5 and Comparative Examples 1 to 6, the following substances were used as the abrasives and the hydrophobic dispersion media.

### (Abrasives)

As the abrasives, abrasives were used in which the composition is aluminum oxide, the α-transformation rate is 95%, the average secondary particle diameter (D50) is 0.8 μm, the (D10−D90)/D50 is 1.1, and the specific surface area is 14.1 m²/g.

For the measurement of the α-transformation rate of the aluminum oxide particles, an X-ray analyzer (Ultima-IV, manufactured by Rigaku Co., Ltd.) was used and, as a reference substance, commercially available α-alumina single crystal particles (α-transformation rate: 100%) were used, in which the firing temperature is sufficiently high and the α-transformation sufficiently proceeds. For the reference substance and the target abrasives (aluminum oxide particles), the integrated intensity of the (113) plane diffraction line by X-ray diffraction measurement was measured. Based on the integrated intensity ratio of the (113) plane diffraction line of the target abrasives to the reference substance, the α-transformation rate of the target abrasives (aluminum oxide particles) was calculated.

The average secondary particle diameter (D50), the D10, and the D90 of the abrasives were measured by resistive pulse sensing using a Multisizer 3 (manufactured by Beckman Coulter, Inc.). The specific surface area of the abrasives was measured by the BET method using a Macsorb HM model-1201 (manufactured by MOUNTECH Co., Ltd.).

### (Hydrophobic Dispersion Medium)

The following substances were used as the hydrophobic dispersion media. A hydrophobic dispersion medium was used which is mineral oil-derived synthetic hydrocarbon (isoparaffinic hydrocarbon) and has a flash point of 63° C. (closed cup method), a total content of a benzene organic solvent and a halogen organic solvent of 0.5 mass % or less, and a vapor pressure of 0.05 kPa (molecular weight of 170). The vapor pressure is a value at 20° C.

### (Object to be Polished)

As the object to be polished, a composite material having a clear coating film applied to the surface of a steel plate with a synthetic resin paint and subjected to baking at 60° C. The clear coating film after baking has a pencil hardness of F.

### (Polishing Machine)

As a polishing machine, a double action polisher LHR12E (manufactured by RUPES) was used.

### (Polishing Conditions)

The polishing conditions are as follows.
Polishing buff: Sponge buff
Press load: 4 kg
Polisher rotation speed: 5300 rpm
Polishing linear speed: 200 m/min
Polishing composition flow rate: 0.6 g/30 sec
Polishing time: 30 sec
Polishing area: 400×600 mm

### (Cleaning, Wiping)

To evaluate the wiping property of the polishing compositions according to Examples 1 to 5 and Comparative Examples 1 to 6, cleaning treatment and wiping treatment were performed in the order of Steps 1 to 6 described below. Thereafter, the wiping property was evaluated.

### Step 1

The surface of the object to be polished was polished in the vertical direction under the above-described polishing conditions, followed by standing for 1 hour, and then water was applied (such that the surface was wet).

### Step 2

A cleaning liquid diluted to 25-fold in a container was foamed.

### Step 3

A soft cloth made of wool was dipped in the container and thoroughly soaked with the cleaning liquid. The cloth thoroughly soaked with the cleaning liquid was brought into contact with the surface of the object to be polished, and then lightly rubbed against the surface of the object to be polished while the cleaning liquid was foamed to lightly clean the surface of the object to be polished.

### Step 4

The surface of the object to be polished was cleaned with water to wash away the cleaning liquid.

### Step 5

Air was blown onto the surface of the object to be polished to remove water.

### Step 6

The surface of the object to be polished was lightly wiped with a cloth.

### (Evaluation of Wiping Property)

After performing the treatment from Steps 1 to 6 above, the present inventors visually confirmed the presence or absence of white cloudiness (sticking components) on the surface of the object to be polished to evaluate the wiping property. A case where the white cloudiness (sticking components) was not able to be visually confirmed was determined that no sticking components were present on the surface of the object to be polished (i.e., clear coating film) (Good: ∘). A case where the white cloudiness (sticking components) was able to be visually confirmed was determined that the sticking components were present on the surface of the object to be polished (i.e., clear coating film) (Bad: x).

As shown in Table 1, in all of Examples 1 to 5, no sticking components were present, and the wiping property was Good: ∘. On the other hand, in all of Comparative Examples 1 to 6, the sticking components were present, and the wiping property was bad:

### (Evaluation of Stability)

The present inventors evaluated the stability for the polishing compositions according to Examples 1 to 5 that had been determined to have a good wiping property. Herein, the stability means that a state in which a moisture component and an oil component are uniformly mixed (i.e., emulsified state) is maintained in the polishing composition. A case where it was visually confirmed that the emulsified state was maintained after the lapse of a certain period of time after the production of the polishing composition was determined that the polishing composition has the stability (Good: ∘). A case where it was visually confirmed that the emulsified state was not maintained (i.e., divided into a water layer and an oil layer) was determined that the polishing composition does not have the stability (Bad: x).

As shown in Table 1, Examples 1 to 5 all maintained the emulsified state and had the stability (Good: ∘).

### Other Embodiments

Although this art is described with reference to the embodiments and the examples, the discussion and the drawings forming part of this disclosure should not be understood as limiting this art. Various alternative embodiments, examples, and operational arts will be apparent to those skilled in the art from this disclosure. It is a matter of course that this art includes various embodiments, which are not described herein. At least one of various omissions, substitutions, and alternations of the constituent components can be performed without departing from the gist of the embodiments and the examples described above. Further, the effects described in this specification are merely examples and are not limited, and other effects may also be involved.

The present invention can also take the following structures.

(1)

A polishing composition containing abrasives, a hydrophobic dispersion medium, water, and a surfactant, in which
the surfactant contains polyoxyethylene alkyl ether represented by Formula (i) RO—(C₂H₄O)ₙ—H, and
in Formula (i) above, R is a branched-chain alkyl group having a number of carbon atoms of 12 or more and 20 or less, and n represents the average number of added moles in oxyethylene and is 3 or more and 50 or less.
   (2)

The polishing composition according to (1) above, in which the average number of added moles n is 5 or more and 15 or less.

(3)

The polishing composition according to (1) or (2) above, in which the HLB value indicating the affinity with water and oil of the surfactant is 10 or more and 16 or less.

(4)

The polishing composition according to any one of (1) to (3) above, in which the abrasives are contained in a proportion of 5 mass % or more and 30 mass % or less based on the total mass of the polishing composition.

(5)

The polishing composition according to any one of (1) to (4) above, in which the abrasives contain aluminum oxide.

(6)

The polishing composition according to (5) above, in which the aluminum oxide has the α-transformation rate of 50% or more and 100% or less.

(7)

The polishing composition according to any one of (1) to (6) above, in which
the hydrophobic dispersion medium contains
at least one selected from the group consisting of normal paraffinic hydrocarbons, isoparaffinic hydrocarbons, naphthenic hydrocarbons, and terpene hydrocarbons, and has
a flash point of 30° C. or more and 100° C. or less.
   (8)

The polishing composition according to any one of (1) to (7) above, in which the hydrophobic dispersion medium has a vapor pressure at 20° C. of 0.004 kPa or more and 2 kPa or less.

(9)

A method for producing a polishing composition including:
a step of mixing abrasives, a hydrophobic dispersion medium, water, and a surfactant to produce a polishing composition, in which
the surfactant contains polyoxyethylene alkyl ether represented by Formula (i) RO—(C₂H₄O)ₙ—H, and
in Formula (i) above, R is a branched-chain alkyl group having a number of carbon atoms of 12 or more and 20 or less, and n represents the average number of added moles of oxyethylene and is 3 or more and 50 or less.
   (10)

A polishing method including a step of polishing an object to be polished using the polishing composition according to any one of (1) to (8) above.

(11)

The polishing method according to (10) above, in which the object to be polished contains at least one selected from the group consisting of resin materials, alloy materials, and glass materials.

(12)

The polishing method according to (10) or (11) above, in which, in the step of polishing the object to be polished,
the polishing composition is supplied to the surface of the object to be polished, and a polishing buff is brought into contact with the surface to which the polishing composition has been supplied for polishing.

### REFERENCE SIGNS LIST

1 automatic polishing device
2 robot arm
4 polishing tool
5 pressing force detector
7 controller
10 polishing buff
10a polishing surface
20, 21, 22 joint
23 tip portion
90 object to be polished

1. A polishing composition comprising:
abrasives;
a hydrophobic dispersion medium;
water; and
a surfactant, wherein
the surfactant contains polyoxyethylene alkyl ether represented by Formula (i) RO—(C₂H₄O)ₙ—H, and
in Formula (i) above, R is a branched-chain alkyl group having a number of carbon atoms of 12 or more and 20 or less, and n represents an average number of added moles in oxyethylene and is 3 or more and 50 or less.

2. The polishing composition according to claim 1, wherein the average number of added moles n is 5 or more and 15 or less.

3. The polishing composition according to claim 1, wherein an HLB value indicating affinity with water and oil of the surfactant is 10 or more and 16 or less.

4. The polishing composition according to claim 1, wherein the abrasives are contained in a proportion of 5 mass % or more and 30 mass % or less based on a total mass of the polishing composition.

5. The polishing composition according to claim 1, wherein the abrasives contain aluminum oxide.

6. The polishing composition according to claim 5, wherein the aluminum oxide has an α-transformation rate of 50% or more and 100% or less.

7. The polishing composition according to claim 1, wherein
the hydrophobic dispersion medium contains at least one selected from the group consisting of normal paraffinic hydrocarbons, isoparaffinic hydrocarbons, naphthenic hydrocarbons, and terpene hydrocarbons, and as
the hydrophobic dispersion medium has a flash point of 30° C. or more and 100° C. or less.

8. The polishing composition according to claim 1, wherein the hydrophobic dispersion medium has a vapor pressure at 20° C. of 0.004 kPa or more and 2 kPa or less.

9. A method for producing a polishing composition comprising:
mixing abrasives, a hydrophobic dispersion medium, water, and a surfactant to produce a polishing composition, wherein
the surfactant contains polyoxyethylene alkyl ether represented by Formula (i) RO—(C₂H₄O)ₙ—H, and
in Formula (i) above, R is a branched-chain alkyl group having a number of carbon atoms of 12 or more and 20 or less, and n represents an average number of added moles of oxyethylene and is 3 or more and 50 or less.

10. A polishing method comprising:
polishing an object to be polished using the polishing composition according to claim 1.

11. The polishing method according to claim 10, wherein the object to be polished contains at least one selected from the group consisting of resin materials, alloy materials, and glass materials.

12. The polishing method according to claim 10, wherein, in the polishing the object to be polished,
the polishing composition is supplied to a surface of the object to be polished, and a polishing buff is brought into contact with the surface to which the polishing composition has been supplied for polishing.

13. The polishing composition according to claim 2, wherein an HLB value indicating affinity with water and oil of the surfactant is 10 or more and 16 or less.

14. The polishing composition according to claim 2, wherein the abrasives are contained in a proportion of 5 mass % or more and 30 mass % or less based on a total mass of the polishing composition.

15. The polishing composition according to claim 2, wherein the abrasives contain aluminum oxide.

16. The polishing composition according to claim 2, wherein
the hydrophobic dispersion medium contains at least one selected from the group consisting of normal paraffinic hydrocarbons, isoparaffinic hydrocarbons, naphthenic hydrocarbons, and terpene hydrocarbons, and as
the hydrophobic dispersion medium has a flash point of 30° C. or more and 100° C. or less.

17. The polishing composition according to claim 2, wherein the hydrophobic dispersion medium has a vapor pressure at 20° C. of 0.004 kPa or more and 2 kPa or less.
